(19) United States
(12) Patent Application Publication
(10) Pub. No.: US 2007/0021315 A1
(43) Pub. Date: Jan. 25, 2007

(54) Water precipitation softening system for detergents, bleaching agents and machine and hand dishwashing agents

(76) Inventor: Rudolf Weber, Duesseldorf (DE)

Correspondence Address: PAUL & PAUL, 2900 TWO THOUSAND MARKET STREET, PHILADELPHIA, PA, 19103, US

(21) Appl. No.: 11/489,336

(22) Filed: Jul. 19, 2006

Related U.S. Application Data
(63) Continuation of application No. PCT/EP05/00109, filed on Jan. 8, 2005.

(30) Foreign Application Priority Data
Jan. 22, 2004 (DE) DE1002004003286.6

(51) Int. Cl. C11D 3/395

(52) U.S. Cl. 510/302

(57) ABSTRACT

Hard water is softened by a composition comprising a fatty acid and/or an alkali salt thereof, a dispersing agent and a precipitation softener thereby simultaneously forming and dispersing an insoluble calcium salt of the fatty acid.

### CROSS-REFERENCE TO RELATED APPLICATIONS

This application is a continuation under 35 U.S.C. §§ 365(c) and 120 of International Application PCT/EP2005/000109, filed Jan. 8, 2005. This application also claims German priority under 35 U.S.C. § 119 of DE 10 2004 003 286.6, filed Jan. 22, 2004. Each application is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

This invention relates to a method for softening water by the combined use of dispersing agent(s), fatty acid(s) and/or its/their alkali salt(s), and precipitation softener(s), as well as a corresponding water softening agent and the use thereof, as well as washing and cleaning agents that contain such water softening agents.

One of the prerequisites for problem-free functioning of washing and dishwashing agents is the presence of soft water. There are a variety of possibilities for eliminating troublesome water hardness. The oldest method is precipitation softening, e.g., using soda or soda/water glass mixtures. A disadvantage of this method is its multiple-step nature, i.e. the hard water must first have the hardness removed from it with the precipitation softener, and no laundry must be added during this precipitation process; otherwise troublesome calcium carbonate deposits occur on the laundry. Only after proper water softening can the actual washing agent be used.

Because of this problem, washing agents having a high soda content have been usable only in regions with soft water, or in commercial laundries that operate with softened water.

The novel water softening method described below makes it possible to work with formulations containing a high level of soda without causing troublesome calcium carbonate deposits to occur on laundry and on washing equipment.

The basic idea of the invention is stepwise softening of the water with simultaneous dispersion of the troublesome precipitation products. For this purpose, in addition to a precipitation softener such as, for example, soda, sodium bicarbonate, potassium carbonate, potassium bicarbonate, or water-soluble silicates, the soap that reacts very quickly with water hardness is used. In this case the result of the soap is that insoluble calcium soap is formed immediately in a first reaction, and the slower-reacting soda (or sodium bicarbonate, etc.) thus finds no further calcium in the water, and no further precipitation reactions take place.

To ensure that no troublesome flakes of calcium soap precipitate, the soap must be immediately dispersed. This is advantageously done by way of a dispersing agent, in particular, the sodium salt of polyaspartic acid. Polyaspartate, for example, disperses calcium soap in very finely divided fashion and keeps it suspended, so that opalescent solutions result and the known flake-like calcium-soap precipitates fail to occur.

(2) Description of Related Art

Including Information Disclosed Under 37 C.F.R. §§ 1.97 and 1.98. Not Applicable

### BRIEF SUMMARY OF THE INVENTION

The subject matter of the present invention is therefore a method for softening water, comprising contacting hard water with a composition comprising a fatty acid and/or an alkali salt thereof, a dispersing agent and a precipitation softener, thereby simultaneously forming and dispersing an insoluble calcium salt of the fatty acid.

### BRIEF DESCRIPTION OF THE SEVERAL VIEWS OF THE DRAWING(S)

Not Applicable

### DETAILED DESCRIPTION OF THE INVENTION

According to a preferred embodiment of the invention, the dispersing agent is selected from polyaspartic acid, the water-soluble polyaspartic acid salts, polyacrylic acid, the water-soluble polyacrylic acid salts, sulfonated or sulfated oils (e.g. Turkey-red oil), block copolymers of the PEP-PEO type (copolymers of polyethylenepropylene and polyethylene oxide), sodium dodecyl sulfate, polymeric polycarboxylates, sodium phosphates, and mixtures thereof.

The polymeric polycarboxylates are preferably homo- or copolymers that contain acrylic-acid and/or maleic-acid units. In the context of this invention it is particularly preferred to use homopolymers, if applicable in combination with copolymers, polyacrylates once again being preferred here. The polyacrylates are usually used in the form of sodium salts. In particular, polyacrylates that preferably have a molecular weight from 3,000 to 8,000, and particularly preferably from 4,000 to 5,000, g/mol have proven particularly well suited according to the present invention. The molar weights indicated in this document for polymeric polycarboxylates are weight-averaged molar weights Mw that were determined in principle by means of gel permeation chromatography (GPC), a UV detector having been used. The measurement was performed against an external polyacrylic acid standard that, because of its structural relationship to the polymers being investigated, yielded realistic molecular weight values. These indications deviate considerably from the molecular weight indications in which polystyrenesulfonic acids are used as the standard. The molar weights measured against polystyrenesulfonic acids are usually higher than the molar weights indicated in this document.

The copolymeric polycarboxylates are, in particular, those of acrylic acid with methacrylic acid, and of acrylic acid or methacrylic acid with maleic acid, which have a molar weight of between 20,000 and 70,000 g/mol. Copolymers of acrylic acid with maleic acid that contain 50 to 90 wt % acrylic acid and 50 to 10 wt % maleic acid have proven particularly suitable. To improve water solubility, the polymers can also contain allylsulfonic acids, allyloxybenzenesulfonic acid, and methallylsulfonic acid as monomers. Also particularly preferred are biodegradable polymers made up of more than two different monomer units, which polymers contain, as monomers, salts of acrylic acid and of maleic acid as well as vinyl alcohol or vinyl alcohol derivatives or, as monomers, salts of acrylic acid and of 2-alkylallylsulfonic acid, as well as sugar derivatives. Additional preferred copolymers comprise, as monomers, preferably acrolein and acrylic acid/acrylic acid salts, or acrolein and vinyl acetate. In a preferred variant, both these copolymers and the polyacrylates are used in the method, the ratio of the polyacrylate to the acrylic acid-maleic acid copolymer advantageously being in the range from 2:1 to 1:20, preferably 1:1 to 1:15.

According to a further preferred embodiment, the fatty acid is selected from hexanoic acid, octanoic acid, decanoic acid, lauric acid, myristic acid, palmitic acid, stearic acid, lauroleic acid, myristoleic acid, palmitoleic acid, oleic acid, ricinoleic acid, linoleic acid, linolenic acid, behenic acid, gadoleic acid, erucic acid, and other unsaturated fatty acids preferably from C₂₀ to C₂₂, as well as mixtures thereof, and their alkali salts.

In washing tests, formulations that contain, for example, soda/soap mixtures and, for example, maleic acid-acrylic acid copolymer in the form of the sodium salt as dispersing agent, produced almost no further ash deposits in the form of calcium carbonate. The dispersed Ca soap results, advantageously, in a slightly elevated, acceptable incrustation. Advantageously, these incrustations in fact have a positive effect, since they brighten the laundry and give it a soft hand, so that, in particular, additional conditioners can be omitted.

According to a preferred embodiment of the invention, the weight ratio of fatty acid and/or its alkali salt to the dispersing agent is 20:1 to 1:3, preferably 10:1 to 2:1.

According to a further preferred embodiment, the weight ratio of precipitation softener, preferably alkali carbonate, alkali bicarbonate, water-soluble silicates, and mixtures thereof, to the dispersing agent is 20:1 to 2:1, preferably 10:1 to 2:1.

When the combination of dispersing agents, fatty acids and/or their alkali salts, and precipitation softeners is used in concentrations in the range from 10 to 60 wt %, in particular, 16 to 50 wt %, based on the entire agent, in particular, washing agent, a further preferred embodiment of the invention then exists.

With the additional use of compounds having a strongly complexing action, such as, for example, imidosuccinic acid, nitrilotriacetic acid, citric acid, carboxymethyltartronic acid or -malic acid and/or their alkali salts, sodium phosphates, ethylenediaminetetraacetate, phosphonates such as aminotrismethylenephosphonic acid (ATMP), it is moreover possible to control the quantity of calcium soap as desired, and to reactivate the Ca soap into washing soap. The intensity of the brightening properties of the Ca soap is thus also adjustable.

Correspondingly, according to a preferred embodiment, strongly complexing compounds such as, in particular, those recited above or comparably acting ones that complex Ca are additionally used.

The weight ratio of dispersing agent to the strongly complexing compounds is, according to a further preferred embodiment, 5:1 to 1:5, preferably 1:1 to 3:1.

The phosphonates are, in particular, hydroxyalkane- or aminoalkanephosphonates. Among the hydroxyalkanephosphonates, 1-hydroxyethane-1,1-diphosphonate (HEDP) is particularly important. It is preferably utilized as a sodium salt; the disodium salt reacts neutrally, and the tetrasodium salt at alkaline pH (9). Suitable aminioalkanephosphonates are preferably ethylenediaminetetramethylenephosphonate (EDTMP), diethylenetriaminepentamethylenephosphonate (DTPMP), and their higher homologs. They are preferably utilized in the form of the neutrally reacting sodium salts, e.g. as the hexasodium salt of EDTMP or as the hepta- and octasodium salt of DTPMP. HEDP (1-(hydroxyethylidene)biphosphonate) is also preferred for use. The aminoalkanephosphonates moreover possess a pronounced ability to bind heavy metals. It may accordingly be preferred, especially when the agents also contain bleaches, to use aminoalkanephosphonates, in particular, DTPMP, or to utilize mixtures of the aforesaid phosphonates. Such phosphonates are contained in the agents advantageously in quantities from 0.05 to 2.0 wt %, preferably in quantities from 0.1 to 1 wt %.

Suitable complexing agents are, for example, the following complexing agents, designated according to INCI, that are described in more detail in the International Cosmetic Ingredient Dictionary and Handbook: Aminotrimethylene Phosphonic Acid, Beta-Alanine Diacetic Acid, Calcium Disodium EDTA, Cyclodextrin, Cyclohexanediamine Tetraacetic Acid, Diammonium EDTA, Diethylenetriamine Pentamethylene Phosphonic Acid, Dipotassium EDTA, Disodium Azacycloheptane Disphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Pentetate, Pentasodium Triphosphate, Pentetic Acid, Phytic Acid, Potassium Citrate, Potassium Gluconate, Potassium Polyphosphate, Ribonic Acid, Sodium Dihydroxyethylglycinate, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA, and Trisodium Phosphate.

Also usable as complexing agents are tertiary amines, in particular, tertiary alkanolamines (amino alcohols). The alkanolamines possess both amino and hydroxy and/or ether groups as functional groups. Particularly preferred tertiary alkanolamines are triethanolamine and tetra-2-hydroxypropylethylenediamine (N,N,N′,N′-tetrakis-(2-hydroxypropyl)ethylenediamine).

A further subject of the invention is a water softening agent containing a dispersing agent, a fatty acid and/or its alkali salt, and a precipitation softener that is preferably selected from alkali carbonate and/or alkali bicarbonate and/or water-soluble silicate. The statements made above also preferably apply to the water softening agents.

According to a preferred embodiment, it contains 10 to 70 wt % precipitation softener, preferably alkali carbonate and/or alkali bicarbonate, 5 to 20 wt % fatty acid and/or its alkali salt, 0-25 wt %, preferably 8 to 20 wt %, peroxygen compound, 0 to 10 wt %, preferably 2 to 8 wt %, nonionic surfactant, 0 to 15 wt %, preferably 3 to 10 wt %, anionic surfactant, and dispersing agent, preferably in quantities from 4 to 25 wt %, advantageously from 5 to 25 wt %, more advantageously from 6 to 20 wt %, even more advantageously from 7 to 16 wt %, in particular, from 8 to 12 wt %.

As described above, additional complexing agents preferably also can be contained.

The water softening agent can be applied onto usual washing-agent formulations or integrated thereinto, for example, onto those constructed on the basis of a sheet silicate (e.g. SKS-6) or zeolite.

The formulations preferably contain water-soluble builders, which corresponds to a preferred embodiment; in this case it is preferred if the proportion of water-insoluble builders is then less than 3 wt % based on the entire formulation.

If the context is, on the other hand, predominantly zeolite-containing or sheet silicate-containing formulations or mixtures thereof, accelerated softening can be achieved by way of the softening system described here.

According to a preferred embodiment, the builder base in such a case is made of up of water-insoluble ion exchangers such as, preferably, sheet silicate (e.g. SKS-6) or zeolite, e.g. of the A, X, Y, or P type.

The ion exchanger quantities are preferably between 8 and 70 wt %, preferably between 25 and 50 wt %.

According to a further preferred embodiment, the agent according to the present invention furthermore contains foam inhibitors, preferably those based on silicone oils or paraffin oils.

It is thus advantageously possible, using economical water-soluble substances having a precipitation-softening action such as, for example, soda, bicarbonate, and silicates, to formulate products that yield excellent secondary washing properties. In the case of mixtures of soda with bicarbonate, for example, the pH can be set in the manner necessary for delicate fabric washing agents. In the case of washing agents for very severely stained laundry (such as work clothes), mixtures having high pH values can be produced, for example, with the aid of water-soluble silicates and soda, for a powerful washing effect.

As bleaching agents it is possible to use, for example, depending on the intended application and the application temperature, alone or mixed, sodium percarbonate and/or sodium perborate, advantageously combined with a bleach activator such as TAED (N,N,N′,N′-tetraacetylethylenediamine) or sodium-p-nonanoyl oxybenzenesulfonate. For washing temperatures around 30° C., the bleaching agent phthalimidoperoxohexanoic acid (PAP) can be used, additionally or alone. For example, a mixture of PAP with percarbonate and TAD yields a bleaching agent for the utilization range from 20 to 60° C., the antibacterial properties of the PAP being additionally exploited by way of its use.

According to a preferred embodiment, a water softening agent according to the present invention contains, as a peroxygen compound, alkali percarbonate, alkali perborate, alkali peracetic acid (TAED), or phthalimidoperoxohexanoic acid, and/or mixtures thereof.

A further subject of the invention consists in the use of a water softening agent, as described above, as a washing agent, washing adjuvant, bleaching agent, cleaning agent, dishwashing and automatic dishwashing agent, or as a constituent of such agents.

A further subject of the invention is represented by a washing and cleaning agent that contains a water softening agent as described above.

A washing and cleaning agent of this kind can comprise, in addition to the water softening agent contained therein, all usual features and ingredients, inferable from the existing art, that characterize a washing and cleaning agent.

Important ingredients of the washing and/or cleaning agent according to the present invention are anionic, zwitterionic, amphoteric, and/or nonionic surfactants, in particular, anionic surfactants. These include, in particular, sulfonates and sulfates.

Cationic surfactants can likewise be contained in the washing and cleaning agent. In a further preferred embodiment of the invention, a cationic surfactant is contained in the washing and cleaning agents in quantities up to 5 wt %, preferably in quantities up to 4 wt %, in particular, in quantities from 1 to 3 wt %, based on the entire washing and cleaning agent. In addition to the softness aspect, improvements in graying and secondary washing effect are also thereby achieved.

In a preferred embodiment of the invention, the cationic surfactant contained in the washing and cleaning agent is a quaternary ammonium compound, preferably an alkylated quaternary ammonium compound.

According to a preferred embodiment, this is a quaternary ammonium compound according to formula (I)
R¹(R²)(R³)(R⁴)N⁺X⁻, (I)
where R¹, R², and R³ are selected, independently of one another, from C₁-C₄ alkyl, C₁-C₄ hydroxyalkyl, benzyl, and —(C₂H₄O)ₙH, where x equals 2 to 5, and R⁴ is a C₈-C₂₂ alkyl, and X⁻ is an anion, preferably a halide, methosulfate, methophosphate, or phosphate ion, as well as mixtures thereof.

According to a further preferred embodiment of the invention, the quaternary ammonium compound is one according to formula (II)
R⁵R⁶ₙR⁷₃₋ₙN⁺X⁻, (II)
where R⁵ is a C₆-C₂₄ alkyl or alkenyl, where each R⁶, independently of one another, is a —(CₙH₂ₙO)ₓR⁸ group, with n equal to 1 to 4 and x equal to 1 to 14, and R⁸ is a methyl, ethyl, or preferably a hydrogen, and where each R⁷, independently of one another, is a C₁-C₂₁ alkyl or alkenyl group with m equal to 1 to 3, and where X⁻ is an anion, preferably a halide, methosulfate, methophosphate, or phosphate ion, as well as mixtures thereof. R⁶ is, in particular, a —CH₂CH₂OH group, R⁷ is, in particular, independently of one another in each case, a C₁-C₄ alkyl with m equal to 1 to 2, and R⁵ is, in particular. a linear C₆-C₁₄ alkyl group.

The washing and cleaning agents according to the present invention that contain quaternary ammonium compounds according to formula (I) and/or (II) are advantageous because when appropriately applied, their result is not only that textiles become very soft and supple, have a reduced drying time, are easier to iron, and if applicable even have antistatic properties, but also that improvements are achieved in some cases with regard to incrustation susceptibility, whiteness, graying, and secondary washing effect. Advantages are obtained in terms of the formation of incrustations on substrate surfaces.

In a preferred embodiment, the cationic surfactant is a C₈-C₁₆ alkyldi(hydroxyethyl)methylammonium compound, preferably a C₁₂-C₁₄ alkyldi(hydroxyethyl)methylammonium compound, and/or a C₈-C₁₆ alkyl(hydroxyethyl)dimethylammonium compound, preferably a C₁₂-C₁₄ alkyl(hydroxyethyl)dimethylammonium compound, in particular, the respective halides, methosulfates, methophosphates, or phosphates, or mixtures thereof.

The aforesaid cationic compounds are ideal in the context of this invention, but other cationic surfactants can nevertheless also be used advantageously. However, alkylated quaternary ammonium compounds, preferably having two hydrophobic groups, which are linked, in particular, via ester or amido bonds to a quaternized di- or triethanolamine or to an analogous compound.

Such compounds are advantageously selected from the formula below (III): 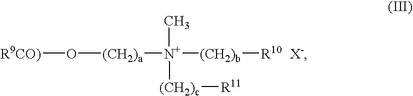
where R⁹ denotes an aliphatic alkyl radical having 12 to 22 carbon atoms having 0, 1, 2, or 3 double bonds; R¹⁰ denotes H, OH, or, in particular, O(CO)R¹², R¹¹ denotes, independently of R¹⁰, H, OH, or O(CO)R³, where R¹² and R¹³, independently of one another, each denote an aliphatic alkyl radical having 12 to 22 carbon atoms having 0, 1, 2, or 3 double bonds, a, b, and c can have, independently of one another in each case, the value 1, 2, or 3, and X⁻ is a suitable anion, preferably a halide, methosulfate, methophosphate, or phosphate ion, as well as mixtures thereof; and/or can conform to formula (IV): 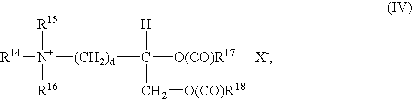
where R¹⁴, R⁵, and R¹⁶, independently of one another, denote a C₁₋₄ alkyl, alkenyl, or hydroxyalkyl group, R¹⁷ and R¹⁸, each selected independently, represent a C₈₋₂₈ alkyl group having 0, 1, 2, or 3 double bonds, and u is a number between 0 and 5, and X⁻ is a suitable anion, preferably a halide, methosulfate, methophosphate, or phosphate ion, and mixtures thereof.

Preferred representatives of this species are N-methyl-N(2-hydroxyethyl)N,N-ditallowacyloxyethyl)ammonium methosulfate or N-methyl-N(2-hydroxyethyl)-N,N-(dipalmitoylethyl)ammonium methosulfate.

Possible anionic surfactants will now be described in more detail. Suitable as surfactants of the sulfonate type are, preferably, C₉-C₁₃ alkylbenzenesulfonates, olefinsulfonates, i.e. mixtures of alkene- and hydroxyalkanesulfonates, as well as disulfonates that are obtained, for example, from C₁₂-C₁₈ monoolefins having an end-located or internal double bond resulting from sulfonation with gaseous sulfur trioxide and subsequent alkaline or acid hydrolysis of the sulfonation products.

Also suitable are alkanesulfonates that are obtained from C₁₂-C₁₈ alkanes, for example, by sulfochlorination or sulfoxidation with subsequent hydrolysis or neutralization.

Also suitable are the esters of alpha-sulfofatty acids (ester sulfonates), e.g., the alpha-sulfonated methyl esters of hydrogenated coconut, palm kernel, or tallow fatty acids, that are produced by alpha-sulfonation of the methyl esters of fatty acids of vegetable and/or animal origin having 8 to 20 C atoms in the fatty acid molecule, and subsequent neutralization to water-soluble mono-salts. These are preferably the alpha-sulfonated esters of hydrogenated coconut, palm, palm kernel, or tallow fatty acids; sulfonation products of unsaturated fatty acids, for example, oleic acid, can also be present in small quantities, preferably in quantities no greater than approximately 2 to 3 wt %. Particularly preferred are alpha-sulfofatty acid alkyl esters that comprise an alkyl chain having no more than 4 C atoms in the ester group, for example, methyl esters, ethyl esters, propyl esters, and butyl esters. It is particularly advantageous to use the methyl esters of the alpha-sulfofatty acids (MES), but also their saponified di-salts.

Further suitable anionic surfactants are sulfonated fatty acid glycerol esters, which represent mono-, di-, and triesters, and mixtures thereof, such as those obtained during manufacture by esterification using a monoglycerol with 1 to 3 mol fatty acid, or upon transesterification of triglycerides with 0.3 to 2 mol glycerol.

Preferred as alk(en)yl sulfates are the alkali and, in particular, sodium salts of the sulfuric acid semi-esters of the C₁₂-C₁₈ fatty alcohols, for example, from coconut fatty alcohol, tallow fatty alcohol, lauryl, myristyl, cetyl, or stearyl alcohol, or of the C₁₀-C₂₀ oxo alcohols, and those semi-esters of secondary alcohols having that chain length. Also preferred are alk(en)yl sulfates having the aforesaid chain length which contain a synthetic straight-chain alkyl radical, produced on a petrochemical basis, that possess degradation characteristics analogous to those of appropriate compounds based on fat-chemistry raw materials. The C₁₂-C₁₆ alkyl sulfates and C₁₂-C₁₅ alkyl sulfates, as well as C₁₄-C₁₅ alkyl sulfates, are particularly preferred in terms of washing technology.

Also suitable are the sulfuric acid monoesters of the straight-chain or branched C₇-C₂, alcohols ethoxylated with 1 to 6 mol ethylene oxide, such as 2-methyl branched C₉-C₁₁ alcohols having an average of 3.5 mol ethylene oxide (EO), or C₁₂-C₁₈ fatty alcohols having 1 to 4 EO. Because of their vigorous foaming characteristics they are used in washing agents only in relatively small quantities, for example, in quantities from 1 to 5 wt %.

Further suitable anionic surfactants are also the salts of alkylsulfosuccinic acid, which are also referred to as sulfosuccinates or sulfosuccinic acid esters, and which represent the monoesters and/or diesters of sulfosuccinic acid with alcohols, preferably fatty alcohols, and in particular, ethoxylated fatty alcohols. Preferred sulfosuccinates contain C₈ to C₁₈ fatty alcohol radicals or mixtures thereof. Particularly preferred sulfosuccinates contain a fatty alcohol radical that is derived from ethoxylated fatty alcohols which, considered of themselves, represent nonionic surfactants (see description below). Sulfosuccinates whose fatty alcohol radicals derive from ethoxylated fatty alcohols having a restricted homolog distribution are in turn particularly preferred. It is likewise also possible to use alk(en)ylsuccinic acid having preferably 8 to 18 carbon atoms in the alk(en)yl chain, or salts thereof.

Further possible anionic surfactants are fatty acid derivatives of amino acids, for example, of N-methyltaurine (taurides) and/or of N-methyglycine (sarcosides). Particularly preferred in this context are the sarcosides or sarcosinates, and here especially sarcosinates of higher and, if applicable, mono- or polyunsaturated fatty acids, such as oleyl sarcosinate.

The anionic surfactants can be present in the form of their sodium, potassium, or ammonium salts, and as soluble salts of organic bases, such as mono-, di-, or triethanolamine. The anionic surfactants are preferably present in the form of their sodium or potassium salts, in particular, in the form of the sodium salts.

In addition to the anionic surfactants and zwitterionic and amphoteric surfactants, nonionic surfactants are especially preferred.

The nonionic surfactants used are preferably alkoxylated, advantageously ethoxylated, in particular, primary alcohols preferably having 8 to 18 C atoms and an average of 1 to 12 mol ethylene oxide (EO) per mol of alcohol, in which the alcohol radical can be linear or preferably methyl-branched in the 2-position, or can contain a mixture of linear and methyl-branched radicals, such as those usually present in oxo alcohol radicals.

Particularly preferred, however, are alcohol ethoxylates having linear radicals made up of alcohols of natural origin having 12 to 18 carbon atoms, e.g., from coconut, palm, tallow, or oleyl alcohol, and an average of 2 to 8 EO per mol of alcohol. The preferred ethoxylated alcohols include, for example, C₁₂-C₁₄ alcohols having 3 EO or 4 EO, C₉-C₁₁ alcohols having 7 EO, C₁₃-C₁₅ alcohols having 3 EO, 5 EO, 7 EO, or 8 EO, C₁₂-C₁₈ alcohols having 3 EO, 5 EO, or 7 EO, and mixtures thereof, such as mixtures of C₁₂-C₁₄ alcohol having 3 EO and C₁₂-C₁₈ alcohol having 5 EO. The ethoxylation numbers that are indicated represent statistical averages, which for a specific product may be a whole number or a fractional number. Preferred alcohol ethoxylates exhibit a restricted homolog distribution (=narrow range ethoxylates, NRE). In addition to these nonionic surfactants, fatty alcohols having more than 12 EO can also be used as described above. Examples of these are (tallow) fatty alcohols having 14 EO, 16 EO, 20 EO, 25 EO, 30 EO, or 40 EO.

Also included among the nonionic surfactants are alkyl glycosides having the general formula RO(G)ₓ, in which R denotes a primary straight-chain or methyl-branched aliphatic radical, in particular, one methyl-branched in the 2-position, having 8 to 22, preferably 12 to 18 carbon atoms; and G denotes a glycose unit having 5 or 6 carbon atoms, preferably glucose. The oligomerization number x that indicates the distribution of monoglycosides and oligoglycosides is any number (which, as a magnitude to be determined analytically, can also assume fractional values) between 1 and 10; x is preferably between 1.2 and 1.4.

Likewise suitable are polyhydroxy fatty acid amides of formula (V), in which R¹⁹CO denotes an aliphatic acyl radical having 6 to 22 carbon atoms, R²⁰ denotes hydrogen or an alkyl or hydroxyalkyl radical having 1 to 4 carbon atoms, and Z denotes a linear or branched polyhydroxyalkyl radical having 3 to 10 carbon atoms and 3 to 10 hydroxyl groups: 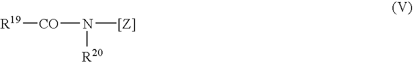
The polyhydroxy fatty acid amides are preferably derived from reducing sugars having 5 or 6 carbon atoms, in particular, from glucose. Also belonging to the group of the polyhydroxy fatty acid amides are compounds of formula (VI) 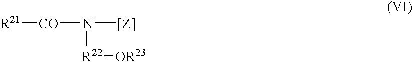
in which R²¹ denotes a linear or branched alkyl or alkenyl radical having 7 to 12 carbon atoms; R²² a linear, branched, or cyclic alkylene radical or an aryl radical having 2 to 8 carbon atoms; and R²³ a linear, branched, or cyclic alkyl radical or an aryl radical or an oxyalkyl radical having 1 to 8 carbon atoms, C₁-C₄ alkyl or phenyl radicals being preferred; and Z denotes a linear polyhydroxyalkyl radical whose alkyl chain is substituted with at least two hydroxyl groups, or alkoxylated, preferably ethoxylated or propoxylated, derivatives of that radical. Here as well, Z is preferably obtained by reductive amination of a sugar such as glucose, fructose, maltose, lactose, galactose, mannose, or xylose. The N-alkoxy- or N-aryloxy-substituted compounds can then be converted to the desired polyhydroxy fatty acid amides, for example, by reaction with fatty acid methyl esters in the presence of an alkoxide as catalyst.

A further class of nonionic surfactants that are preferred for use, which can be used either as the only nonionic surfactant or in combination with other nonionic surfactants, in particular, together with alkoxylated fatty alcohols and/or alkylglycosides, are alkoxylated, preferably ethyoxylated or ethoxylated and propoxylated, fatty acid alkyl esters preferably having 1 to 4 carbon atoms in the alkyl chain, in particular, fatty acid methyl esters, such as those described, for example, in Japanese Patent Application JP 58/217598. Preferred as nonionic surfactants are C₁₂-C₁₈ fatty acid methyl esters having an average of 3 to 15 EO, in particular, having an average of 5 to 12 EO, whereas higher ethoxylated fatty acid methyl esters are especially advantageous (as described above) as binders. In particular, C₁₂-C₁₈ fatty acid methyl esters having 10 to 12 EO can be used both as surfactants and as binders.

Nonionic surfactants of the aminoxide type, for example, N-cocalkyl-N,N-dimethylaminoxide and N-tallowalkyl-N,N-dihydroxyethylaminoxide, and of the fatty acid alkanolamide type, can also be suitable. The quantity of these nonionic surfactants is preferably no more than that of the ethyoxylated fatty alcohols, in particular, no more than half thereof.

Further surfactants that are possible are so-called Gemini surfactants. These are understood in general to be those compounds that possess two hydrophilic groups and two hydrophobic groups per molecule. These groups are usually separated from one another by a so-called “spacer.” This spacer is usually a carbon chain, which should be sufficiently long that the hydrophilic groups have enough spacing so that they can act independently of one another.

Surfactants of this kind are generally characterized by an unusually low critical micelle concentration, and by the ability to greatly reduce the surface tension of the water. In exceptional cases, however, the expression “Gemini surfactants” is understood to mean not only dimeric but also trimeric surfactants. Suitable Gemini surfactants are, for example, sulfated hydroxy mixed ethers or dimer alcohol bis- and trimeralcohol trisulfates and ethersulfates. End-capped dimeric and trimeric mixed ethers are characterized, in particular, by their bi- and multifunctionality. For example, the aforesaid end-capped surfactants possess good wetting properties and are also low-foaming, so that they are particularly suitable for use in automatic washing or cleaning methods. Gemini polyhydroxy fatty acid amides or polypolyhydroxy fatty acid amides can, however, also be used.

Bleaching agents have already been cited above. Of the compounds serving as bleaching agents that yield H₂O₂ in water, sodium perborate tetrahydrate, sodium perborate monohydrate, and sodium percarbonate are of particular importance. Other usable bleaching agents are, for example, peroxypyrophosphates, citrate perhydrates, and peracid salts or peracids that yield H₂O₂, such as perbenzoates, peroxophthalates, diperazelaic acid, phthaloimino peracid, or diperdodecanedioic acid. As already discussed above, in a preferred embodiment sodium percarbonate is used as a bleaching agent.

The other washing agent constituents include graying inhibitors (dirt carriers), foam inhibitors, bleach activators, optical brighteners, enzymes, textile-softening substances, dyes, and fragrances, as well as sulfates and chlorides in the form of their sodium or potassium salts.

Bleach activators have already been cited above. Compounds that, under perhydrolysis conditions, yield aliphatic peroxocarboxylic acids having preferably 1 to 10 carbon atoms, in particular, 2 to 4 carbon atoms, and/or (optionally substituted) perbenzoic acid, can be used as bleach activators. Substances that carry the O- and/or N-acyl groups having the aforesaid number of carbon atoms, and/or optionally substituted benzoyl groups, are suitable.

Multiply acylated alkylenediamines, in particular, tetraacetylethylendiamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoyl succinimide (NOSI), acylated phenolsulfonates, in particular, n-nonanoyl or isononanoyl oxybenzenesulfonate (n- or iso-NOBS), carboxylic acid anhydrides, in particular, phthalic acid anhydride, acylated polyvalent alcohols, in particular, triacetin, ethylene glycol diacetate, 2,5-diacetoxy-2,5-dihydrofuran, and the enol esters known from German Patent Applications DE-A-196 16 693 and DE-A-196 16 767, as well as acetylated sorbitol and mannitol and mixtures thereof (SORMAN) described in European Patent Application EP-A-0 525 239, acylated sugar derivatives, in particular, pentaacetylglucose (PAG), pentaacetylfructose, tetraacetylxylose and octaacetyllactose, as well as acetylated, optionally N-alkylated glucamine and gluconolactone, and/or N-acylated lactams, for example, N-benzoylcaprolactam, are preferred. Hydrophilically substituted acyl acetates and acyl lactams are also used in preferred fashion. Such bleach activators are advantageously contained in the usual quantity range, preferably in quantities from 1 wt % to 10 wt %, in particular, 2 wt % to 8 wt %, based on the entire washing and/or cleaning agent.

Suitable as foam inhibitors are, for example, organopolysiloxanes and mixtures thereof with microfine, optionally silanated silicic acid, as well as paraffins, waxes, microcrystalline waxes, and mixtures thereof with silanated silicic acid or bistearylethylenediamide. It is also advantageous to use mixtures of different foam inhibitors, e.g. those made of silicones, paraffins, or waxes. The foam inhibitors, in particular, silicone- and/or paraffin-containing foam inhibitors, are preferably bound to a granular carrier substance that is soluble or dispersible in water.

Mixtures of paraffins and bistearylethylenediamides are particularly preferred in this context.

Possibilities as enzymes are, in particular, those of the class of the hydrolases, such as the proteases, lipases, or lipolytically acting enzymes, amylases, cellulases, or mixtures thereof. Oxireductases are also suitable.

Enzymatic active substances obtained from bacterial strains or fungi, such as Bacillus subtilis, Bacillus licheniformis, Streptomyceus griseus, and Humicola insolens, are particularly suitable. Proteases of the subtilisin type, and in particular, proteases obtained from Bacillus lentus, are preferably used. Enzyme mixtures, for example, of protease and amylase or protease and lipase or lipolytically active enzymes, or protease and cellulase, or of cellulase and lipase or lipolytically active enzymes, or of protease, amylase, and lipase or lipolytically active enzymes, or protease, lipase or lipolytically active enzymes, and cellulase, but in particular, protease- and/or lipase-containing mixtures or mixtures having lipolytically active enzymes, are of particular interest in this context. Examples of such lipolytically active enzymes are the known cutinases. Peroxidases or oxidases have also proven suitable in certain cases. The suitable amylases include, in particular, alpha-amylases, isoamylases, pullulanases, and pectinases. Cellobiohydrolases, endoglucanases, and beta-glucosidases, which are also called cellobiases, and mixtures thereof, are preferably used as cellulases. Because the different types of cellulase differ in terms of their CMCase and avicelase activities, the desired activities can be set by means of controlled mixtures of the cellulases.

The enzymes can be adsorbed onto carrier materials and/or embedded into coating substances, in order to protect them from premature breakdown. The proportion of enzymes, enzyme mixtures, or enzyme granulates can be, for example, approximately 0.1 to 5 wt %, preferably 0.1 to approximately 2 wt %.

In addition to the phosphonates, the washing and/or cleaning agents can also contain further enzyme stabilizers. For example, 0.5 to 1 wt % sodium formate can be used. Also possible is the use of proteases that are stabilized with soluble calcium salts and have a calcium content of preferably approximately 1.2 wt % based on the enzyme. In addition to calcium salts, magnesium salts also serve as stabilizers. It is particularly advantageous, however, to use boron compounds, for example, boric acid, boroxide, borax, and other alkali-metal borates, such as the salts of orthoboric acid (H₃BO₃), metaboric acid (HBO₂), and pyroboric acid (tetraboric acid, H₂B₄O₇).

Cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, and mixtures thereof, as well as polyvinylpyrrolidone, can preferably be used as graying inhibitors, for example, in quantities of 0.1 to 5 wt % based on the washing and/or cleaning agent.

The washing and/or cleaning agents can contain, as optical brighteners, derivatives of diaminostilbenesulfonic acid or its alkali-metal salts. Suitable, for example, are salts of 4,4′-bis(2-anilino-4-morpholino-1,3,5-triazinyl-6-amino)stilbene-2,2′-disulfonic acid, or similarly structured compounds that carry, instead of the morpholino group, a diethanolamino group, a methylamino group, an anilino group, or a 2-methoxyethylamino group. Brighteners of the substituted diphenylstyryl type can also be present, for example, the alkali salts of 4,4′-bis(2-sulfostyryl)diphenyl, of 4,4′-bis(4-chloro-3-sulfostyryl)diphenyl, or of 4(4-chlorostyryl)-4′-(2-sulfostyryl)-diphenyl. Mixtures of the aforesaid brighteners can also be used.

The washing and/or cleaning agents according to the present invention can, if they are particulate (which is preferred), exhibit any desired bulk density. The palette of possible bulk densities extends from low bulk densities below 600 g/l, for example, 300 g/l, through the range of moderate bulk densities from 600 to 750 g/l, to the range of higher bulk densities of at least 750 g/l. In a preferred variant of the washing and/or cleaning agents having high bulk densities, however, the bulk density is in fact above 800 g/l, in which context bulk densities above 850 g/l can be particularly advantageous.

Any methods known from the existing art are suitable for the production of such washing and/or cleaning agents.

In a production variant that is preferred, in particular, when washing and/or cleaning agents of high bulk density are to be obtained, the washing and/or cleaning agent mixtures are subjected to a final compacting step, in which context, for example, further ingredients can also be mixed into the washing and/or cleaning agent only after the compacting step.

In a preferred embodiment of the invention, compacting of the ingredients takes place using a press agglomeration method. The press agglomeration procedure to which the solid premix (dried base washing agent) is subjected can be implemented in various types of apparatus. Different press agglomeration methods are distinguished based on the type of agglomerator used. The four most common press agglomeration methods, which are preferred in the context of the present invention, are extrusion, roller pressing or compacting, pellet pressing (pelleting), and tableting, so that press agglomeration procedures preferred in the context of the present invention are extrusion, roller compacting, pelleting, or tableting procedures. All the aforesaid preferred compacting methods have in common the fact that the premix is compacted and plasticated under pressure, and the individual particles are pressed together with a reduction in porosity, and adhere to one another. In all the methods (with limitations in the case of tableting), the tools can be heated to higher temperatures, or can be cooled to dissipate the heat resulting from shear forces. In all the methods, a binder can be used as a compaction adjuvant.

### EXAMPLES

The following washing agents were produced according to formulations B to G:

| | B | C | D | E | F | G |
|---|---|---|---|---|---|---|
| | (wt %) | (wt %) | (wt %) | (wt %) | (wt %) | (wt %) |
| Soda | 50 | 50 | 50 | 50 | | |
| Bicarbonate | | | | | 50 | 50 |
| Na sulfate | 15 | 7 | 7 | 3 | 15 | 7 |
| Water glass | 11 | 11 | 11 | 4 | 11 | 11 |
| Perborate | 10 | 10 | | | | |
| Percarbonate | | | 10 | 10 | 10 | 10 |
| Sokalan CP 5 | | 8 | 8 | 8 | | |
| Metasilicate K0 | | | | 11 | | |
| Soap | 7 | 7 | 7 | 7 | 7 | 7 |
| Nonionic | 3 | 3 | 3 | 3 | 3 | 3 |
| surfactant | | | | | | |
| FAS | 4 | 4 | 4 | 4 | 4 | 4 |

Sokalan CP 5: Maleic acid-acrylic acid copolymer, Na salt (30:70)
FAS: Fatty alcohol sulfate

In washing tests (13 washes at 60° C., water hardness 16 degrees German hardness, in automatic drum washing machine; fabric: bleached cotton cloth and terry cloth), secondary washing results were determined by way of parameters such as R value (remission), Berger whiteness, ash, and incrustation. These values are indicated below with reference to the respective formulation; IV indicates the initial value, and A represents a commercial available brand of washing agent.

| | IV | A | B | C | D | E | F | G |
|---|---|---|---|---|---|---|---|---|
| Bleached | | | | | | | | |
| cotton | | | | | | | | |
| cloth | | | | | | | | |
| R value (%) | 84.2 | 84.1 | 82.3 | 80.9 | 80.5 | 80.7 | 81.6 | 80.9 |
| Berger | 76.4 | 169.2 | 157.3 | 159.8 | 157.9 | 157.2 | 157.7 | 159.3 |
| whiteness | | | | | | | | |
| Ash (%) | 0.07 | 0.9 | 3.3 | 0.8 | 1.0 | 1.0 | 3.0 | 0.6 |
| Incrustation | 1.1 | 2.2 | 7.6 | 2.4 | 2.3 | 2.4 | 6.2 | 2.0 |
| (%) | | | | | | | | |
| Terry cloth | | | | | | | | |
| R value (%) | 79.5 | 84.1 | 78.8 | 77.5 | 77.4 | 77.2 | 77.5 | 77.2 |
| Berger | 158.8 | 165.9 | 158.2 | 159.5 | 159.5 | 159.0 | 155.6 | 157.4 |
| whiteness | | | | | | | | |
| Ash (%) | 0.2 | 0.5 | 3.0 | 1.1 | 0.9 | 1.0 | 3.8 | 1.2 |

As the results show, formulations C, D, E, and G, which contained soda (bicarbonate)/soap mixtures and Sokalan CP 5 as a dispersing agent, produced almost no ash deposits in the form of calcium carbonate. Formulations B and F, on the other hand, which contained no dispersing agent, exhibited definite ash deposits. As the tests have shown, the dispersed Ca soap resulted in a slightly elevated but acceptable organic incrustation. These calcium incrustations had a positive effect on the fabric, however, by brightening and softening it.

Further washing tests were also performed (13 washes at 60° C., water hardness 16 degrees German hardness, in automatic drum washing machine) using the following formulations:

| | | B1 | C1 | D1 | | | |
|---|---|---|---|---|---|---|---|
| | A1 | (wt | (wt | (wt | E1 | F1 | G1 |
| | (wt %) | %) | %) | %) | (wt %) | (wt %) | (wt %) |
| ABS | 7 | 7 | 10 | 7 | 10 | 2 | 2 |
| Lutensol | 15 | 12 | 12 | 12 | 12 | | |
| Soap | 10 | 7 | 7 | 7 | 7 | | |
| Soda | 25 | 48 | 48 | 48 | 48 | 32.5 | 32.5 |
| Metasilicate K0 | 25 | | | | | 23.4 | 23.4 |
| Perborate | 10 | 10 | 10 | 10 | 10 | 23 | 23 |
| monohydrate | | | | | | | |
| Sokalan CP 5 | 8 | 8 | 8 | 12 | 12 | | 5 |

Lutensol: C₁₂₋₁₄ fatty alcohol, ethoxylated (8 EO)
ABS: Alkylbenzenesulfonate

After the washing tests, ash was determined in each case to ascertain the secondary washing results.

| | A1 | B1 | C1 | D1 | E1 | F1 | G1 |
|---|---|---|---|---|---|---|---|
| Terry cloth | | | | | | | |
| Ash (%) | 0.47 | 0.99 | 0.95 | 0.44 | 0.27 | | |
| Bleached cotton cloth | | | | | | | |
| Ash (%) | 0.59 | 0.71 | 0.66 | 0.39 | 0.26 | 7.7 | 2.4 |

As the results show, formulations A1 to E1 and G1, which contained soda/soap mixtures and Sokalan CP 5 as a dispersing agent, produced almost no ash deposits in the form of calcium carbonate. Formulation F1, on the other hand, which contained no dispersing agent, showed definite ash deposits.

Further washing tests were additionally performed (13 washes at 60° C., water hardness 16 degrees German hardness, in automatic drum washing machine) with the following formulation (A2):

| | A2 (wt %) |
|---|---|
| Soda | 22 |
| Bicarbonate | 17.25 |
| Sheet silicate | 36 |
| Cellulase | 0.25 |
| PVI/PVP | 0.25 |
| Silicone oil/paraffin oil | 0.25 |
| Sokalan CP 5 | — |
| Polyaspartate | 8 |
| Soap | 5 |
| Nonionic surfactant | 4 |
| FAS | 7 |

The following secondary washing results were obtained in terms of graying, color graying, and ash:

| All values in % | |
|---|---|
| Graying | A2 |
| WFK cotton | 5.0 |
| WFK cotton terry | 4.8 |
| WFK polyester/cotton 65/35 | 6.0 |
| Color graying | 2.9 |
| Ash | 0.8 |

This formulation as well, having polyaspartate as a dispersing agent, yielded an outstanding ash value.

1. A method for softening water comprising contacting hard water with a composition comprising a fatty acid and/or an alkali salt thereof, a dispersing agent and a precipitation softener, thereby simultaneously forming and dispersing an insoluble calcium salt of the fatty acid.

2. The method of claim 1, wherein the precipitation softener is selected from alkali carbonate and/or alkali bicarbonate and/or water-soluble silicate.

3. The method of claim 1, wherein the dispersing agent is selected from the group consisting of polyaspartic acid, the water-soluble polyaspartic acid salts, polyacrylic acid, the water-soluble polyacrylic acid salts, sulfonated or sulfated oils, block copolymers of polyethylenepropylene and polyethylene oxide, sodium dodecyl sulfate, polymeric polycarboxylates, sodium phosphates, and mixtures thereof.

4. The method of claim 1, wherein the weight ratio of fatty acid and/or its alkali salt to the dispersing agent is 20:1 to 1:3.

5. The method of claim 1, wherein the weight ratio of precipitation softener to the dispersing agent is 20:1 to 2:1.

6. The method of claim 1, wherein the concentration of the composition is in the range from 10 to 60 wt %.

7. The method of claim 1, wherein the composition is further comprised of a complexing agent selected from the group consisting of imidosuccinic acid, nitrilotriacetic acid, citric acid, carboxymethyltartronic acid and/or an alkali salt thereof, malic acid and/or an alkali salt thereof, sodium phosphate, ethylenediamine-tetraacetate, phosphonates such as aminotrismethylenephosphonic acid (ATMP), or Ca-complexing compounds having a comparable action, or mixtures thereof, are additionally used.

8. The method of claim 7, wherein the weight ratio of dispersing agent to the complexing agent is 5:1 to 1:5.

9. A water softening agent comprising a fatty acid and/or an alkali salt thereof, a dispersing agent and a precipitation softener.

10. The agent of claim 9 comprising
a) 10 to 70 wt % precipitation softener;
b) 5 to 20 wt % fatty acid and/or its alkali salt;
c) 0 to 25 wt % peroxygen compound;
d) 0 to 10 wt % nonionic surfactant;
e) 0 to 15 wt % anionic surfactant;
f) dispersing agent.

11. The agent of claim 9, wherein the peroxygen compound is an alkali percarbonate, alkali perborate, alkali peracetic acid (TAED), phthalimidoperoxohexanoic acid, and/or mixtures thereof.

12. A washing agent, washing adjuvant, bleaching agent, cleaning agent, dishwashing or automatic dishwashing agent comprising an agent of claim 9.
